(19) United States
(12) Patent Application Publication
(10) Pub. No.: US 2019/0366777 A1
(43) Pub. Date: Dec. 5, 2019

(54) IMPROVED TIRE TREADS HAVING POSITIVELY INCLINED SIPES

(71) Applicants: John Limroth, Simpsonville, SC (US); Mark Collett, Simpsonville, SC (US)

(72) Inventors: John Limroth, Simpsonville, SC (US); Mark Collett, Simpsonville, SC (US)

(73) Assignee: Compagnie Générale des Établissements Michelin, Clermont-Ferrand (FR)

(21) Appl. No.: 16/465,406

(22) PCT Filed: Nov. 29, 2017
(86) PCT No.: PCT/US2017/063794

§ 371 Date: May 30, 2019

(30) Foreign Application Priority Data
Nov. 30, 2016 (US) PCT/US2016/064240

(51) Int. Cl. B60C 11/12; B60C 11/03

(52) U.S. Cl. CPC B60C 11/124; B60C 11/1281; B60C 11/1259; B60C 2011/1209; B60C 11/0302; B60C 2011/1277; B60C 11/1218

(57) ABSTRACT

In particular embodiments, a tire tread includes one or more lateral sipes (26s) arranged within the tread (20). As each such lateral sipe (26s) extends outward from within the tread thickness (T20) and towards the outer, ground-engaging side (22) of the tread (20), the lateral sipe (26s) is inclined towards the intended direction (R) of tire rotation. The lateral sipe (26s) also has a width (W26) (thickness) configured to, at an unworn stage, close along at least a portion of the sipe depth during operation of a loaded tire, and being configured to, at a worn stage, remain open during operation of the loaded tire. The lateral sipe (26s) has a width-to-height ratio associating the sipe width (W26) to the sipe height, the width-to-height ratio equaling 1:10 to 1:40. Providing a plurality of these lateral sipes (26s) may result in improved consistency of tread wear performance over the life of the tread (20).

### CROSS-REFERENCE TO RELATED APPLICATION

This application claims priority to, and the benefit of, International Patent Application No. PCT/US2016/064240, filed Nov. 30, 2016 with the U.S. Patent Office (in the capacity of a Receiving Office), and which is hereby incorporated by reference.

### BACKGROUND

### Field

This disclosure relates generally to tire treads, and more particularly, to tire treads having sipes extending into the tread thickness, where each of the sipes increase in width with increased depth.

### Description of the Related Art

Tire treads are known to include a pattern of discontinuities forming a tread pattern arranged along an outer, ground-engaging side of the tread to provide sufficient traction and handling performance during particular operating conditions. Discontinuities may comprise grooves and/or sipes. Grooves provide void into which water, mud, or other environmental materials may be diverted to better allow the outer, ground-engaging side of the tread to engage a tire operating surface (that is, a surface upon which the tire operates, such as a road or ground surface). Sipes are slits or narrow grooves that at least partially close when engaging a tire operating surface, but which provide edges along the outer, ground-engaging side of the tread to generate traction. By virtue of providing a pattern of discontinuities, tread elements comprising ribs and/or lugs are formed in the tread.

It is well known that the tire tread wears during tire operation as the tire tread slips relative the tire operating surface at the trailing edge of a tread element within a tire footprint. The tire footprint is the area of contact between the tire and the tire operating surface, and which is also referred to as a contact patch. Therefore, there is a desire to reduce this slip and the impact this slip has on tread wear during tire operation.

While it is known to alter the depthwise inclination of a lateral sipe by rotating the depthwise inclination of the lateral sipe in the direction of tire rotation and in the direction of the tread length as the lateral sipe extends outwardly from the tread depth and towards the outer, ground-engaging side of the tread (which is referred to as being positively inclined) to improve wear performance, it has been determined that improvements in tread wear are not consistently observed through the worn life of the tread. Therefore, there is a need to improve the consistency of tread wear performance over the worn life of the tread when employing positively inclined lateral sipes or lateral grooves.

### SUMMARY

In particular embodiments, a tire tread is provided, which may or may not be arranged on a tire. The tire tread includes a length extending in a longitudinal direction, the lengthwise direction being a circumferential direction when the tread is arranged on a tire, a width extending in a lateral direction, the lateral direction being perpendicular to the longitudinal direction, and a thickness extending in a depthwise direction from an outer, ground-engaging side of the tread, the depthwise direction being perpendicular to both the longitudinal direction and the widthwise direction of the tread. The tire tread also includes a lateral sipe arranged within the tread, the sipe having a length extending primarily in the direction of the tread width and a width extending perpendicular to the lateral sipe length. The lateral sipe also has a depthwise extension extending into the tread thickness from a first terminal end to a second terminal end along a path by a height measured in the direction of the tread thickness, the first terminal end being arranged closest to the outer, ground-engaging side relative to the second terminal end. The path has an average inclination angle that is measured in the longitudinal direction of the tread relative to the depthwise direction, the average inclination angle being angled toward an intended forward rotating direction of the tread in the longitudinal direction. The sipe width is formed by a pair of opposing faces of the tread extending depthwise within the tread thickness. The sipe width is configured to, at an unworn stage, close along at least a portion of the sipe depth during operation of a loaded tire, and being configured to, at a worn stage, remain open during operation of the loaded tire. The lateral sipe is characterized as having a width-to-height ratio associating the sipe width to the sipe height, the width-to-height ratio equaling 1:10 to 1:40.

In other embodiments, a method of forming a lateral sipe in a tire tread is provided. The tire tread has a length extending in a longitudinal direction, the lengthwise direction being a circumferential direction when the tread is arranged on a tire, a width extending in a lateral direction, the lateral direction being perpendicular to the longitudinal direction, and a thickness extending in a depthwise direction from an outer, ground-engaging side of the tread, the depthwise direction being perpendicular to both the longitudinal direction and the widthwise direction of the tread. The method includes determining for improved wear performance an optimum positive inclination angle for a lateral void that remains open during tire operation. The method further includes determining a lateral sipe and/or forming a lateral sipe within the tread thickness, the lateral sipe having a length extending primarily in the direction of the tread width and a width extending perpendicular to the lateral sipe length. The lateral sipe has a depthwise extension extending into the tread thickness from a first terminal end to a second terminal end along a path by a height measured in the direction of the tread thickness, the first terminal end being arranged closest to the outer, ground-engaging side relative to the second terminal end. The path has an average inclination angle that is greater than the optimum positive inclination angle, the average inclination angle being measured in the longitudinal direction of the tread relative to the depthwise direction. The average inclination angle is angled toward an intended forward rotating direction of the tread in the longitudinal direction. The lateral sipe is characterized as having a width-to-height ratio associating the lateral sipe width to the sipe height, the width-to-height ratio equaling 1:10 to 1:40. The lateral sipe has a width formed by a pair of opposing faces of the tread extending depthwise within the tread thickness, the sipe width being configured to, at an unworn stage, close along at least a portion of the sipe depth during operation of a loaded tire, and being configured to, at a worn stage, remain open during operation of the loaded tire.

The foregoing and other objects, features and advantages will be apparent from the following more detailed descriptions of particular embodiments, as illustrated in the accompanying drawing wherein like reference numbers represent like parts of the invention.

### BRIEF DESCRIPTION OF THE DRAWINGS

FIG. 1 is a partial perspective view of a tire tread showing a plurality of tread blocks separated by a plurality of discontinuities forming a plurality of lateral and longitudinal grooves and a plurality of lateral sipes, in accordance with an exemplary embodiment.

FIG. 2 is a sectional side view of a lateral sipe of the tire tread of FIG. 1 shown in a normally open arrangement, in accordance with an exemplary embodiment.

FIG. 3 is a sectional side view of the lateral sipe of FIG. 2 shown in a closed arrangement.

FIG. 4 is a sectional side view of the lateral sipe of FIG. 3 shown in a worn arrangement.

FIG. 5 is a sectional side view of a positively inclined lateral sipe with a submerged void arranged at a depthwise terminal end of the sipe, in accordance with another exemplary embodiment.

FIG. 6 is a sectional side view of a lateral sipe of the tire tread of FIG. 1 shown in a normally open arrangement and gradually increasing in width in a continuous manner, in accordance with an exemplary embodiment.

FIG. 7 is a sectional side view of the lateral sipe of FIG. 2 shown in a closed arrangement.

FIG. 8 is a sectional side view of a lateral sipe extending into the tread thickness along a non-linear path and gradually increasing in width in a continuous manner, in accordance with an alternative embodiment to the embodiment shown in FIG. 2.

FIG. 9 is a sectional side view of a lateral sipe extending into the tread thickness along a non-linear path and gradually increasing in width in an intermittent manner, in accordance with an alternative embodiment to the embodiment shown in FIG. 2.

FIG. 10 is a top elevational view showing the discontinuity of FIG. 2 extending linearly along its length, which extends in the lateral direction of the tire tread, in accordance with an exemplary embodiment.

FIG. 11 is a top elevational view showing the discontinuity of FIG. 2 optionally extending linearly along its length, which extends partially in the lateral direction (that is, biased to the lateral direction) of the tire tread, in accordance with an exemplary embodiment.

FIG. 12 is a top elevational view showing the discontinuity of FIG. 2 optionally extending non-linearly along its length, in accordance with an exemplary embodiment.

FIG. 13 is a perspective view of a tire tread having a windowpane sipe, in accordance with an exemplary embodiment.

FIG. 14 is a perspective view of the windowpane sipe shown in FIG. 13.

FIG. 15 is a sectional side view of the windowpane sipe of FIGS. 13 and 14, the sipe being positively angled and having an increasing width in accordance with an exemplary embodiment.

### DETAILED DESCRIPTION OF PARTICULAR EMBODIMENTS

The present invention includes tire treads, tires including said treads, and methods for improving tire wear. For each, a tire tread includes one or more positively inclined lateral sipes each comprising a narrow groove having a width that allows the sipe to close or, in other words, opposing faces of the tire tread forming the width of the sipe to contact, during tire operation. This contact results in rubber-to-rubber contact at some juncture along the height of the lateral sipe. However, by maintaining a width greater than zero (0) at least nearest the depthwise terminal end (referred to as a second terminal end of the lateral sipe herein), the lateral sipe remains open at a worn stage where the opposing faces of the tread forming the lateral sipe remain spaced apart during tire operation. Optionally, in certain embodiments, these lateral sipes are characterized as having a width-to-height ratio of a particular value, where the ratio of the lateral sipe width to the lateral sipe height is 1 to 10 (1:10) to 1 to 40 (1:40), for example. These sipes may have a constant or variable width. Optionally, in certain embodiments, the width of the lateral sipe widens as the lateral sipe extends deeper into the tread thickness and/or a submerged void is arranged at the depthwise terminal end of the lateral sipe (also referred to herein as a “second terminal end”) to maintain the open configuration during tire operation (that is, during the full rotation of a normally loaded tire—that is, under anticipated loads) at a worn stage of the tread (where the tread has a reduced thickness due to wear). This widening lateral sipe may or may not be combined with the characterization of having a particular width-to-height ratio. By virtue of this, the benefits of positively inclining lateral sipes are better realized, and more consistent wear performance over the worn life of the tire tread is achieved.

It has been observed that while positively inclined lateral sipes improve tire tread wear performance by reducing the slip generated when a tread block exits a tire footprint, the improvement can be reduced when at least a portion of the sipe width closes. It has been determined, however, that the benefits of positively inclining the lateral sipe are better (more efficiently) realized when the sipe remains open, that is, where this rubber-to-rubber contact is eliminated. Because the effect of Poisson's ratio (bulging) decreases as the tread thickness decreases during the worn life of the tire, the improvements described herein utilize this characteristic to configure positively inclined lateral sipes to remain open (no rubber-to-rubber contact) at a worn stage of a tire tread, that is, after a portion of the tread thickness has been removed, recognizing that the Poisson effect will be reduced at the worn stage, such that the bulging of the tread from each opposing face forming the lateral sipe is reduced. It is noted that for any given tread, tread wear benefits attributed to positively inclining lateral sipes vary with changes in the positive inclination angle. Of particular note, it has been observed that tread wear benefits increase with increasing positive inclination angles up to an optimum positive inclination angle, and thereafter the tread wear benefits decrease with increasing positive inclination angles, assuming the sipe remains open during tire operation. However, it has also been determined that when a lateral sipe closes, due to the Poisson effect, the lateral sipe operates as if it was originally formed at a lower positive inclination angle. Therefore, in certain instances, where the tread wear benefits vary between different positive inclination angles, an original positive inclination angle is selected that is greater than the optimum positive inclination angle. This selection is performed with regard to the new stage, relative to an optimum positive inclination angle for the new stage. This originally formed lateral sipe inclination angle (the “original positive inclination angle”) references the molded inclination angle or an undeformed (unloaded) inclination angle of the lateral sipe at the new stage. It is appreciated that these positive angles may be associated with an average positive inclination angle for the lateral sipe, which is later introduced below. By selecting a positive inclination angle greater than the optimum, when the tread is compressed under loaded tire operation, in the new (or first) stage, the lateral sipe operates as if the unloaded positive inclination is lower, meaning, the tread wear benefits are equivalent to those that would otherwise be achieved at a lower angle if the sipe would not have closed. So, it is possible to form the sipe at a less-than-optimum original positive inclination angle that is greater than the optimum, and still obtain optimum or near optimum tread wear performance when the sipe closes during tire operation in the new stage and wen the sipe remains open at a subsequent worn stage. By allowing the positively inclined lateral sipe width to remain open at the worn stage of the tread thickness, the wear benefits resulting from positively inclining the lateral sipe are better realized. To improve tread wear consistency over the worn life of the tire tread, in further embodiments, providing a more gradual reduction in the Poisson effect over the depth of the positively inclined lateral sipe may be achieved by allowing the width of the lateral sipe to increase as the sipe extends deeper into the tread thickness. Additionally, or in the alternative, in certain variations, a submerged groove is arranged at the depthwise terminal end of the lateral sipe to provide further separation between opposing sides of the tread forming the lateral sipe.

As a lead-in to further discussions surrounding the lateral sipes, a tire tread is more generally introduced. A tire tread can generally be described as having a length extending in a longitudinal direction. As the tread may be formed with the tire, or separately for later installation on the tire, such as during retreading operations, for example, the lengthwise direction of the tread is a circumferential (that is, annular) direction when the tread is arranged on a tire. A tire tread also has a width extending in a lateral direction, the lateral direction being perpendicular to the longitudinal direction. A tire tread also has a thickness extending in a depthwise direction from an outer, ground-engaging side of the tread. The thickness terminates at a bottom side of the tread. Each of the depthwise direction, the longitudinal direction, and the widthwise direction of the tread is perpendicular to the other.

As noted previously, one or more positively inclined lateral sipes are arranged within the tread. Each sipe has a length extending primarily in the direction of the tread width, that is, in a direction 45 degrees or less biased from the direction of the tread width (that is, the lateral direction). The sipe length may also extend linearly or non-linearly along any linear or non-linear path. Each sipe also has a width (also referred to as a thickness) extending perpendicular to the lateral sipe length. The sipe width is defined by a pair of opposing faces of the tread. The sipe width is configured such that: (1) while in a new (unworn) stage, the sipe width closes along at least a portion of the sipe depth during operation of a loaded tire, where the tire tread is exposed to compressive forces within a footprint of the tire, and (2) at a worn stage, where a portion of the tread thickness has been removed such that the depth or height of the lateral sipe has been reduced, the sipe width remains open during operation of a loaded tire. This may be achieved by selecting a sipe having a particular width that is not too narrow, whether the sipe has a constant width or a variable width, such as, for example, a width that widens with increasing extension into the tread depth, and/or a sipe that is characterized as having a particular width-to-height ratio. The sipe height is measured in the direction of the tread thickness, which is a radial direction when the tread is installed on an annular tire. Because the depthwise extension of the lateral sipe extends into the tread positively inclined relative to the direction of the tread thickness, the distance by which the depthwise extension of the lateral sipe extends within the tread thickness is greater than the height of the lateral sipe.

In particular instances the lateral sipe width is variable, generally increasing as the sipe extends deeper into the tread thickness from a first terminal end and to a second terminal end. For any sipe, this increase in width may be intermittent or continuous, or any combination thereof, along the depth of the sipe. When increasing continuously, this may occur gradually in a linear or curvilinear progression. The sipe width is configured to articulate between an open configuration and a closed configuration as the tire rotates during tire operation, where in the closed configuration, the pair of opposing faces at or near the first terminal end engage one another while the pair of opposing faces at or near the second terminal end remain spaced apart. In certain instances, the lateral sipe width ranges from 0 to 1.4 mm (millimeters) at any location along the sipe height, and in more specific instances, ranges from 0.15 mm to 0.2 mm at any location along the sipe height. At the depthwise terminal end (the second terminal end) of the lateral sipe, the lateral sipe width is greater than zero (0), and in certain instances, at least 0.15 to 0.2 mm wide. In certain instances, the depthwise extension of the lateral sipe into the tread thickness can be described as having a thin portion and a wide portion, the thin portion having a width that is thinner than a width of the wide portion. For example, the thin portion may have a width of 0 to 0.2 mm while the thick portion is greater than the thin portion and up to 1.4 mm. In other variations, whether the sipe width widens or remains constant, the second terminal end of the sipe may include or terminate into a submerged void having a width wider than the lateral sipe width and extending partially or fully along the length of the lateral sipe. It is appreciated that the sipe width may gradually increase beyond a threshold width to transition to a submerged void width and thereby define the submerged void, or the sipe width may abruptly transition from the sipe to the submerged void. While the submerged void may have any desired width, in exemplary instances, the submerged void has a width of 0.5 to 3.0 mm and may have any desired height greater than zero (0).

It is also appreciated, whether or not the sipe width remains constant or varies and/or whether the sipe terminates into any submerged void at the second terminal end, the lateral sipe is characterized as having a particular relationship between the sipe width and sipe height, which is referred to herein as a width-to-height ratio. It is appreciated that the deeper the sipe extends into the tread thickness, the more each opposing face bulges into the sipe width due to the Poisson effect—for any given tread design. Therefore, for the purposes of achieving the purposes discussed herein, as the height of the lateral sipe increases, so does the sipe width—within a desired range of a width-to-height ratio. For example, in certain instances, for a positively inclined lateral sipe having a constant sipe width, in the new stage, sipe closure is obtained when the sipe width is 0.2 mm and the sipe height is 8 mm, which provides a 1:40 width-to-height ratio. By further example, in another instance, sipe closure in the new stage is obtained for a positively inclined lateral sipe having a constant sipe width when the sipe width is 0.15 mm and the sipe height is 6 mm, which also provides a 1:40 width-to-height ratio. In yet another example, sipe closure in the new stage is obtained for a positively inclined lateral sipe having a constant sipe width when the sipe width is 0.4 mm and the sipe height is 8 mm, which provides a 1:20 width-to-height ratio. It is appreciated that in other embodiments, the width-to-height ratio may at least 1:10, where no upper limit is provided since a lateral sipe having a zero (0) width, such as when forming a laceration, would provide a ratio of 1 to infinity. In more narrow instances, range from 1:10 to 1:40 or 1:20 to 1:40. It is appreciated that the width is used in the width-to-height ratio is either the width of a constant width lateral sipe or the average width of a variable width sipe.

As noted previously, in extending into the tread thickness, each sipe extends from a first terminal end and to a second terminal end of the sipe to define a height of the sipe, the first terminal end being located closest to the outer, ground-engaging side of the tread relative to the second terminal end. It is appreciated that the first terminal end may be arranged along the outer, ground-engaging side or submerged below the outer, ground-engaging side, such as when the sipe is a submerged sipe that is later exposed to the outer, ground-engaging side after a thickness of the tread is worn away or otherwise removed.

Each sipe also extends into the tread thickness along a path from the first terminal end and to the second terminal end. This path is defined to extend midway between a pair of opposing faces of the tire tread that form the lateral sipe, the path extending midway between these opposing faces for the full depth of the lateral sipe. This path may be linear or non-linear. For each sipe, the path is characterized as having an average inclination angle that is positive. This average inclination angle is determined by averaging the inclination angles for the path over the full length of the path. This average inclination angle may be obtained by using linear regression when the path is non-linear. In such instances, linear regression is used to determine a line based upon the non-linear path.

In measuring the angularity of the non-linear path, and any portion thereof, or the path along which any face forming the discontinuity extends, as discussed herein, from the direction of the tread thickness, “the direction of the tread thickness” is also referred to as the “depthwise” direction of the tread. “The direction of the tread thickness” extends perpendicular to the tread width and the tread length. When the tire tread is installed on an annual tire, “the direction of the tread thickness” is a radial direction, extending radially from a rotational axis of the tire. Consistent therewith, such angularity can also be measured relative to a plane extending in both the direction of the tread width and the direction of the tread thickness, where “the direction of the tread thickness” extends along this plane. Angularity is measured with reference to a reference line extending in the direction of the tread thickness or the plane and an origin located on the reference line or plane as the subject portion of any path being measured extends toward the outer, ground-engaging side of the tread from within the tread thickness. This origin is not necessarily the location for measuring the angle, but rather a location to describe a positively or negatively biased angle. It is noted that a positive angle is an angle that extends in the direction of intended tire rotation relative the direction of the tread thickness as the angle extends towards the outer, ground-engaging side, while a negative angle extends in the opposite direction. In other words, a positively inclined lateral sipe extends outward from within the tread thickness and towards the outer, ground-engaging side of the tread, the lateral sipe being inclined towards the intended direction of tire rotation. Any non-zero angle can be expressed as forming two vectors, one vector extending in the direction of the tread thickness towards the outer, ground-engaging side and the other vector extending in the longitudinal direction of the tread, where for a positive angle, this latter (second) vector extending in the longitudinal direction extends in the direction of intended forward tire rotation, and where for a negative angle, this latter vector extends in the direction opposite to the direction of intended forward tire rotation (that is, in the direction of intended reverse tire rotation). The direction of intended forward rotation is the direction the tire rotates when the vehicle upon which it is mounted travels in a forward direction, that is, in the direction opposite of a reverse direction. Any portion of the tread positively inclined leans in the direction of intended forward rotation as the portion of the tread extends from within the tread thickness and towards the outer, ground-engaging side of the tread.

While a positive inclination angle requires the average inclination angle to be greater than zero (0), and while the average inclination angle may be any angle greater than zero (0), in specific instances, the average inclination angle is at least 3 degrees or at least 5 degrees. In other instances, the average inclination angle is up to 15 degrees or up to 60 degrees. In certain embodiments, the path along which the sipe extends depthwise into the tread thickness is positively inclined the full depth of the sipe, where in certain instances, beyond being inclined at an angle greater than zero (0), such as by any angle contemplated above with regard to the average inclination angle, for example. In instances where the positive inclination angle for a lateral sipe is selected to be greater than an optimum positive inclination angle for a lateral sipe or groove that remains open (does not close) during tire operation in a new (unworn) stage, it is appreciated that the positive inclination angle for the lateral sipe can be any angle greater than the optimum. For example, in certain instances, the positive inclination angle employed for the lateral sipe may be double (2×) the optimum positive inclination angle or may be 10 to 30 degrees greater than the optimum positive inclination angle. It is also noted that when selecting a particular positive inclination angle for the lateral sipe, directionally, the width-to-height ratio will increase with increasing positive inclination angles and decrease with decreasing positive inclination angles. In view of this, by example, the lateral sipe width for a higher degree positive inclination angle would be thinner as compared to the width for a lateral sipe width for a lower degree positive inclination angle.

In other instances, a positive inclination of the sipe may be defined with regard to each of the pair of opposing faces. Particularly, each of the pair of opposing faces extends depthwise into the tread thickness along a path, where for a first face of the pair of opposing faces extends along a first path and for a second face of the pair of opposing faces extends along a second path. Each of these first and second paths may be linear or non-linear, and may or may not extend along the same path. Each of the first and second paths is characterized as having an average inclination angle that is positive. This average inclination angle is determined for each of the first and second path by averaging the inclination angles for the respective path over the full length of the respective path. This average inclination angle may be obtained by using linear regression when the corresponding path is non-linear. In such instances, linear regression is used to determine a line based upon the non-linear path. The average inclination angle is then the angle by which the line is biased from the direction of the tread thickness as described above. It is appreciated that the average inclination angle may be any angle contemplated above for the average inclination angle of the path extending midway between the opposing faces.

Because selection of a positive inclination angle, width, and width-to-height ratio for any lateral sipe will vary based upon other factors, such as the tread material (compound) and the tread block size, in one example, where the tread is made of an all-season tread material, lateral sipes having an average width of 0.4 mm arranged in tread blocks (lugs) that are spaced along the tread length, center-to-center, by 9 mm and have a height of 8 mm, have a width-to-height ratio of 1:20 and an average positive inclination angle of 20 degrees, where 10 degrees is optimum. For a winter tire using a lower modulus tread material and/or smaller blocks, a width-to-height ratio of 1:10 may be employed, for example.

It is appreciated that a lateral sipe having an increasing width and a positive inclination angle or average inclination angle described above may be applied to and incorporated into any desired lateral sipe. For example, use of the positive inclination angle or average inclination angle together with an increasing width with increasing depth may be applied to windowpane sipes. Likewise, a method of forming a lateral sipe in a tire tread is generally described, where method includes determining for improved wear performance an optimum positive inclination angle for a lateral void that remains open during tire operation, and then determining and ultimately forming a lateral sipe within the tread thickness having an inclination angle that is greater than the optimum positive inclination angle. The optimum positive inclination angle may be determined using finite element analysis or other modelling or simulation programs, or any other method known to one of ordinary skill in the art. More specifically, the lateral sipe being determined and formed in the tread thickness has a length extending primarily in the direction of the tread width and a width extending perpendicular to the lateral sipe length. The lateral sipe has a depthwise extension extending into the tread thickness from a first terminal end to a second terminal end along a path by a height measured in the direction of the tread thickness, the first terminal end being arranged closest to the outer, ground-engaging side relative to the second terminal end. The path has an average inclination angle that is greater than the optimum positive inclination angle, the average inclination angle being measured in the longitudinal direction of the tread relative to the depthwise direction whereby the average inclination angle is angled toward an intended forward rotating direction of the tread in the longitudinal direction. The lateral sipe is characterized as having a width-to-height ratio associating the lateral sipe width to the sipe height, the width-to-height ratio equaling 1:10 to 1:40. The lateral sipe has a width formed by a pair of opposing faces of the tread extending depthwise within the tread thickness, the sipe width being configured to, at an unworn stage, close along at least a portion of the sipe depth during operation of a loaded tire, and being configured to, at a worn stage, remain open during operation of the loaded tire. At this worn stage, the tire tread thickness may be at any location be 25% worn, 50% worn, 75% worn, or at least 2 mm or 4 mm worn, for example.

It is noted that any tire tread may include a plurality of these lateral sipes, such as where the plurality of lateral sipes form all lateral sipes contained in the tire tread, or only a portion thereof. It may be that a plurality of these lateral sipes are configured to coexist in a tire footprint during tire operation, where a footprint is the area of contact between a tire and a ground surface.

Exemplary embodiments of the tire treads discussed above will now be described in association with the figures.

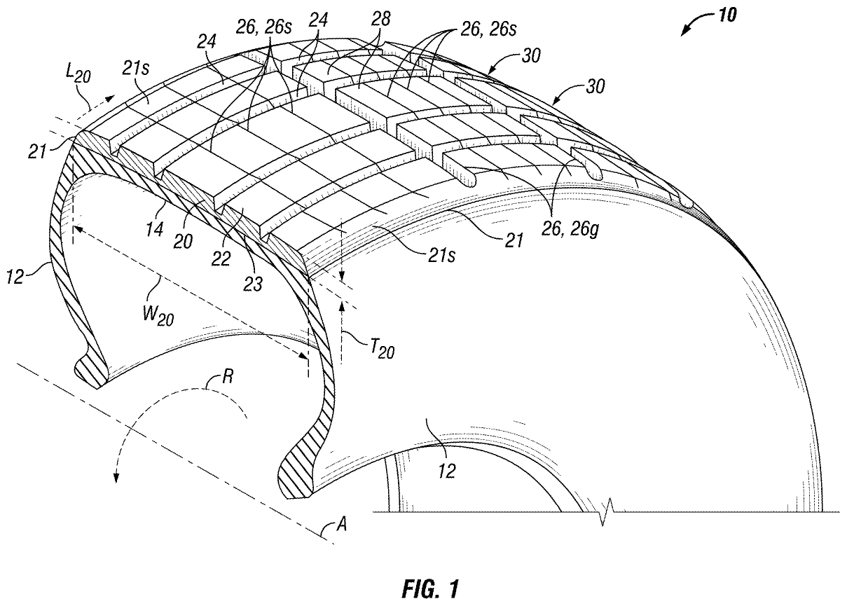

With reference to an exemplary embodiment of FIG. 1, a pneumatic tire 10 is shown. The tire 10 includes a pair of sidewalls 12 each extending radially outward from a rotational axis A of the tire and to a central portion 14 of the tire 10. The central portion 14 of the tire includes a tread 20 having a thickness T₂₀ extending depthwise in a radial direction toward the rotational axis A of the tire from an outer, ground-engaging side 22 of the tread 20 to a bottom side 24 for attachment and bonding to the tire. The tread also has a width W₂₀ extending in a lateral direction between a pair of opposing, lateral sides or side edges 21 of the tread arranged adjacent to sidewalls 12. The tread also includes a pair of shoulders 21s arranged along each side 21 extending along the tread thickness T₂₀. With regard to the tread 20, it is shown to include a plurality of longitudinal grooves 24 having a length extending in the direction of the tread length L₂₀, which in this instance is in a circumferential direction of the tire. The longitudinal grooves 24, together with lateral discontinuities 26, define a plurality of tread elements 28. Lateral discontinuities comprise lateral grooves 26g and lateral sipes 26s. Tread elements 28 arranged adjacent one another to form a row of tread elements extending in the direction of the tread length form a rib 30. The plurality of ribs include a pair of shoulder ribs 28s bounded by a lateral side 21 of the tread width W₂₀. It is noted generally that any lateral groove, such as lateral grooves 26g, may be inclined as any lateral sipe, such as lateral sipes 26, in any embodiment contemplated herein or variation thereof.

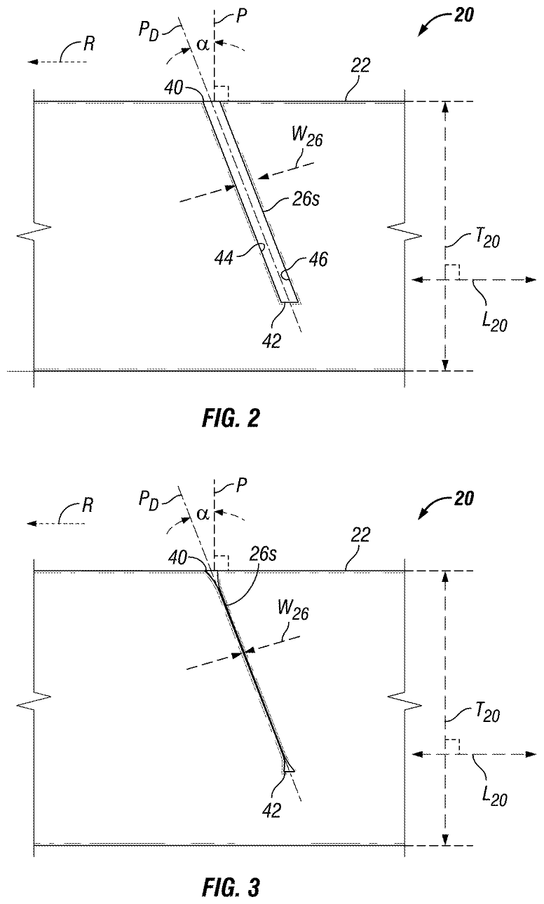

With reference now to FIG. 2, a lateral sipe 26s from FIG. 1 is shown in a new or unworn stage. Lateral sipe 26s forms one of a plurality of lateral sipes 26s arranged at different locations along the tread length and width, where each are characterized the same, meaning, each include the same features. Lateral sipe 26s has a width W₂₆ (which is also referred to a “thickness” of the sipe) and a height H₂₆ that extends into the depth of the tread thickness T₂₀ between a first terminal end 40 and a second terminal end 42 along a path P_{D}. This path P_{D} is defined to extend midway across the width W₂₆ between a pair of opposing faces 44, 46 of the tire tread 20 forming the lateral sipe 26s, the path extending midway between these opposing faces 44, 46 for the full depth of the lateral sipe. The sipe width W₂₆ remains constant as the sipe extends deeper into the tread thickness from the first terminal end 40. Because path P_{D} is linear, the angle α by which the path P_{D} is positively angled (biased) relative to the direction of the tread thickness T₂₀ is also the average inclination angle for the path P_{D}. With brief reference to the opposing terminal ends 40, 42 of the depthwise extension of lateral sipe 26s, the first terminal end 40 is located closest to the outer, ground-engaging side 22 of the tread 20 relative to the second terminal end 42. While it is contemplated that the first terminal end 40 may be arranged below the outer, ground-engaging side 22, such as when the lateral sipe 26s is a submerged sipe intended to become exposed to the outer, ground-engaging side 22 after an intervening thickness of the tire tread is worn away or otherwise removed, in the embodiment shown, the first terminal end 40 is arranged along the outer, ground-engaging side 22.

While the lateral sipe 26s has been described in FIG. 2 as extending depthwise within the tread thickness T₂₀ along a path P_{D}, the sipe can also be described with reference to the pair of opposing faces 44, 46 of the tread that form and define the lateral sipe 26s. Specifically, the first face 44 of the pair of opposing faces extends along a first path P1_{D}, while the second face 46 of the pair of opposing faces extends along a second path P2_{D}. Because the width W₂₆ of the lateral sipe 26s remains constant along the depthwise extension of the sipe, at least one the first and second paths P1_{D}, P2_{D} follow a path the same as path P_{D}. It is appreciated that for the lateral sipe 26s shown in FIG. 2, paths P_{D}, P1_{D}, P2_{D}, as well as the width W₂₆ may be characterized in any manner contemplated herein.

With reference now to FIG. 3, the lateral sipe 26s of FIG. 2, shown in an undeformed, normally open configuration, is now shown in a closed configuration where the lateral sipe 26s has been deformed by way of the Poisson effect. In view thereof, the sipe width W₂₆ in the undeformed configuration is configured to articulate between the open configuration and the closed configuration as the tire rotates during tire operation, where in the closed configuration, the pair of opposing faces 44, 46 at or near the first terminal end 40 engage one another while the pair of opposing faces 44, 46 at or near the second terminal end 42 remain spaced apart.

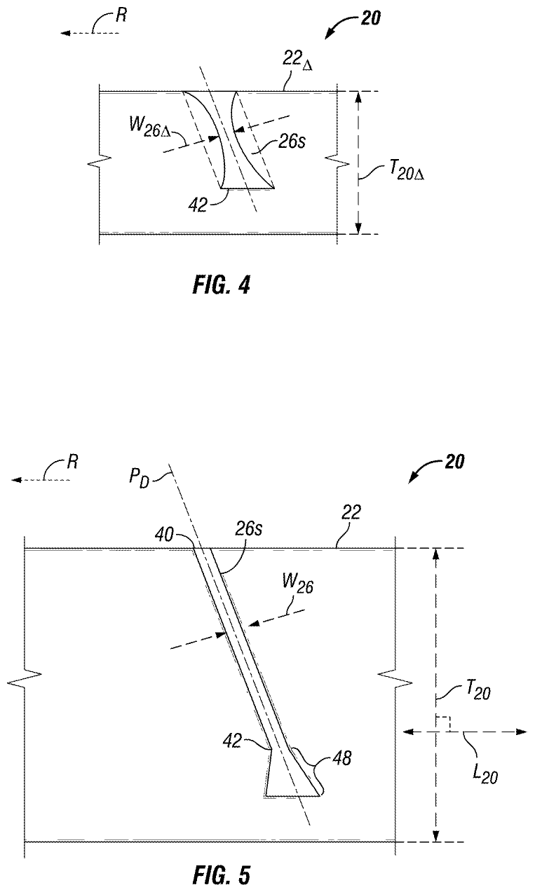

Reference is now made to FIG. 4, where the tread 20 and sipe 26s of FIGS. 2 and 3 are now shown in a worn stage. In this worn stage, the tread thickness has been worn to a thinner, worn thickness T_{20Δ} such that the outer, ground-engaging side 22Δ has moved deeper into the tread thickness. Particularly, the tread 20 is shown in a loaded state during tire operation with the tread 20 being compressed, but where the lateral sipe 26s remains in an open configuration without closing as it did in the unworn state shown in FIG. 3. With reference to the dashed lines, the tread 20 and lateral sipe 26s are shown in the worn but unloaded state prior to tire operation. By utilizing the sipe widths discussed herein, whether directly or by use of the sipe width-to-height ratios, the sipe is able to remain open at a worn stage of the tread thickness.

In addition to, or in lieu of using the sipe widths discussed herein, a submerged void may be arranged at the depthwise terminal end (that is, at the second terminal end of the sipe) to permit an open arrangement at a worn stage of the positively inclined lateral discontinuity. In the exemplary embodiment shown in FIG. 5, a positively inclined lateral discontinuity 26 includes a lateral sipe 26s and a lateral void 48 located at the second terminal end 42 of the lateral sipe 26s. While the lateral void 48 may comprise any void of any shape having a width that is wider than lateral sipe 26s, in this embodiment, the lateral void 48 forms a lateral groove with a gradually increasing width W₄₈ that increases as the lateral void 48 extends deeper into the tread thickness.

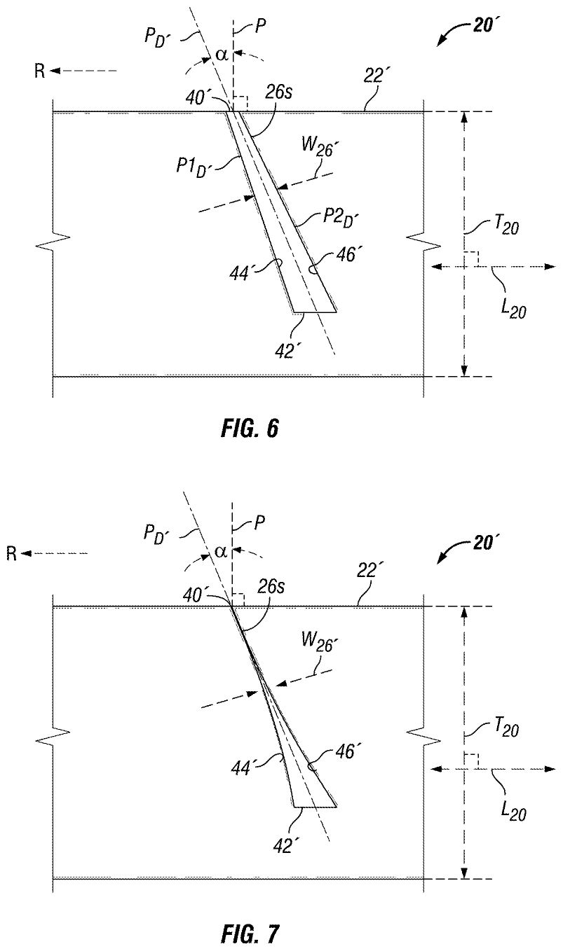

With reference now to FIG. 6, an alternative lateral sipe 26s′ to the sipe 26s of FIG. 2 is shown. The lateral sipe 26s′ has a width W_{26′} and a height H_{26′} that extends into the depth of the tread thickness T_{20′} between a first terminal end 40′ and a second terminal end 42′ along a path P_{D′}. This path P_{D′} is defined to extend midway across the width W_{26′} between a pair of opposing faces 44′, 46′ of the tire tread 20′ forming the lateral sipe 26s′, the path extending midway between these opposing faces 44′, 46′ for the full depth of the lateral sipe. The sipe width W_{26′} generally increases as the sipe extends deeper into the tread thickness from the first terminal end 40′, where the depthwise extension of the lateral sipe can also be described as having a thin portion and a wide portion, the thin portion having a width that is less than a width of the wide portion. In the embodiment shown, the increase in width is achieved linearly and continuously. With brief reference to the opposing terminal ends 40′, 42′ of the depthwise extension of lateral sipe 26s′, the first terminal end 40′ is located closest to the outer, ground-engaging side 22′ of the tread 20′ relative to the second terminal end 42′. While it is contemplated that the first terminal end 40′ may be arranged below the outer, ground-engaging side 22′, such as when the lateral sipe 26s′ is a submerged sipe intended to become exposed to the outer, ground-engaging side 22′ after an intervening thickness of the tire tread is worn away or otherwise removed, in the embodiment shown, the first terminal end 40 is arranged along the outer, ground-engaging side 22′.

While the lateral sipe 26′ has been described in FIG. 6 as extending depthwise within the tread thickness T_{20′} along a path P_{D′}, the sipe can also be described with reference to the pair of opposing faces 44′, 46′ of the tread that form and define the lateral sipe 26s′. Specifically, the first face 44′ of the pair of opposing faces extends along a first path P1_{D′}, while the second face 46′ of the pair of opposing faces extends along a second path P2_{D′}. Because the width W_{26′} of the lateral sipe 26s′ varies along the depthwise extension of the sipe, at least one the first and second paths P1_{D′}, P2_{D′} follow a path different from path P_{D′}. It is appreciated that for the lateral sipe 26s′ shown in FIG. 6, paths P_{D′}, P1_{D′}, P2_{D′}, as well as the width W_{26′} may be characterized in any manner contemplated herein.

With reference now to FIG. 7, the lateral sipe 26s′ of FIG. 6, shown in an undeformed, normally open configuration, is now shown in a closed configuration where the lateral sipe 26s′ has been deformed due to the Poisson effect. In view thereof, the sipe width W_{26′} in the undeformed configuration is configured to articulate between the open configuration and the closed configuration as the tire rotates during tire operation, where in the closed configuration, the pair of opposing faces 44′, 46′ at or near the first terminal end 40′ engage one another while the pair of opposing faces 44′, 46′ at or near the second terminal end 42′ remain spaced apart.

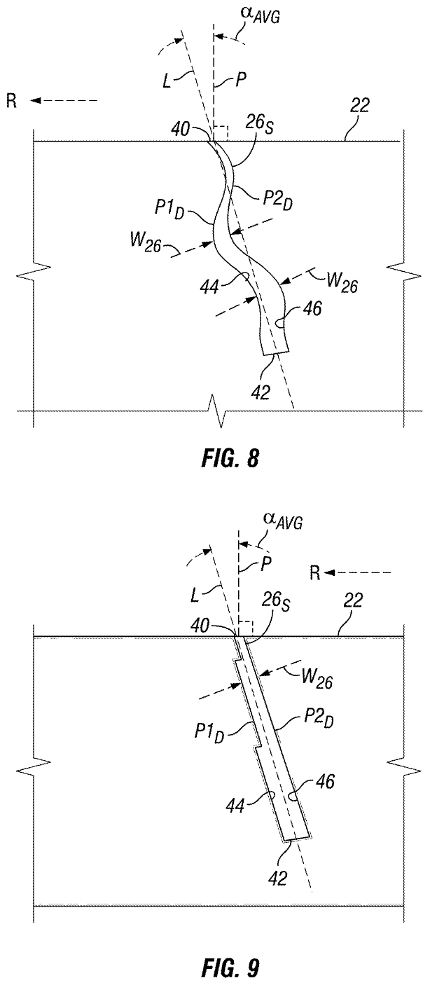

Previously, it was described that a lateral sipe may extend into the tread depth along any desired path, so long as the average inclination angle is positive. For example, with reference to FIG. 8, a lateral sipe 26s is shown intending into the tread thickness T₂₀ along a path P_{D} that is non-linear. More specifically, the non-linear path P_{D} is curvilinear. Opposing faces 44, 46 extend along first and second paths P1_{D}, P2_{D} that are also non-linear and more specifically curvilinear. A line L_{D} is shown extending at a constant angle α relative to plane P, representing the average inclination angle for the non-linear path P_{D}. In one example, the line L_{D} is generated from the non-linear path using linear regression. By further example, with reference now to FIG. 9, a lateral sipe 26s is shown intending into the tread thickness T₂₀ along a path P_{D} that is non-linear. More specifically, the non-linear path P_{D} is stepped, meaning, it is formed of a plurality of linear segments. Opposing faces 44, 46 extend along first and second paths P1_{D}, P2_{D}, one of which is non-linear and more specifically stepped, while the other is linear. A line L_{D} is shown extending at a constant angle α relative to plane P, representing the average inclination angle for the non-linear path P_{D}. In each of FIGS. 8 and 9, the sipe width W_{26′} generally increases as the sipe extends deeper into the tread thickness from the first terminal end 40, where the depthwise extension of the lateral sipe can also be described as having a thin portion and a wide portion, the thin portion having a width that is less than a width of the wide portion.

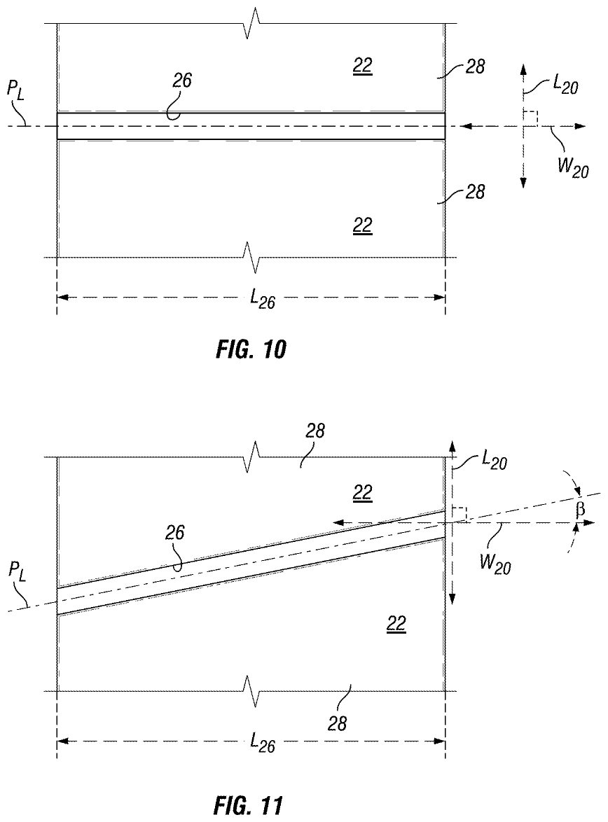

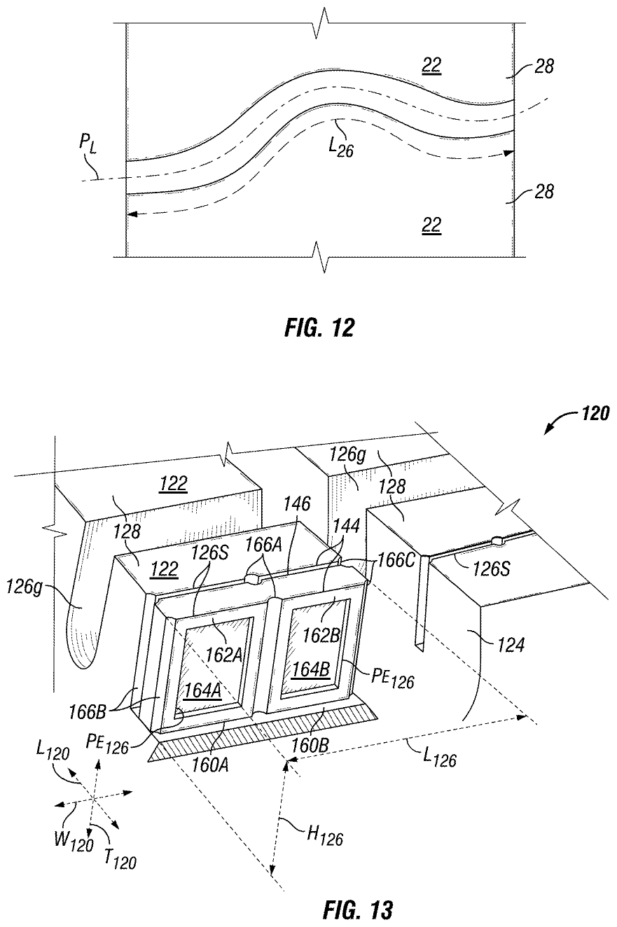

As stated more generally above, the length of the lateral sipe may extend along any desired path at least partially extending in a lateral direction of the tire tread. With reference to FIG. 10, a top elevational view of the lateral sipe 26s shown in FIG. 2 is depicted extending into the outer, ground-engaging side 22 of the tread 20. The length L₂₆ of the lateral sipe 26s is shown extending linearly along path P_{L} in the lateral direction W₂₀ of the tire tread (that is, in the direction of the tread width), unbiased thereto. Optionally, in other exemplary instances, with reference to FIG. 11, a lateral sipe 26s is shown extending linearly along its length L₂₆ along path P_{L}, but which extends partially in the lateral direction W₂₀ of the tire tread. That is, in other words, the path P_{L} is biased to the lateral direction of the tire tread by any angle β so long as the angle is equal to or less than 45 degrees. In another optional exemplary instance, with reference to FIG. 12, a lateral sipe 26s is shown extending non-linearly along its length L₂₆ along path P_{L} in the lateral direction W₂₀ of the tire tread. In any embodiment, the non-linear path may form any desired non-linear path, such as any curvilinear path or any path composed of linear segments. In the exemplary embodiment shown, the non-linear path is a curvilinear path that includes a plurality of undulations.

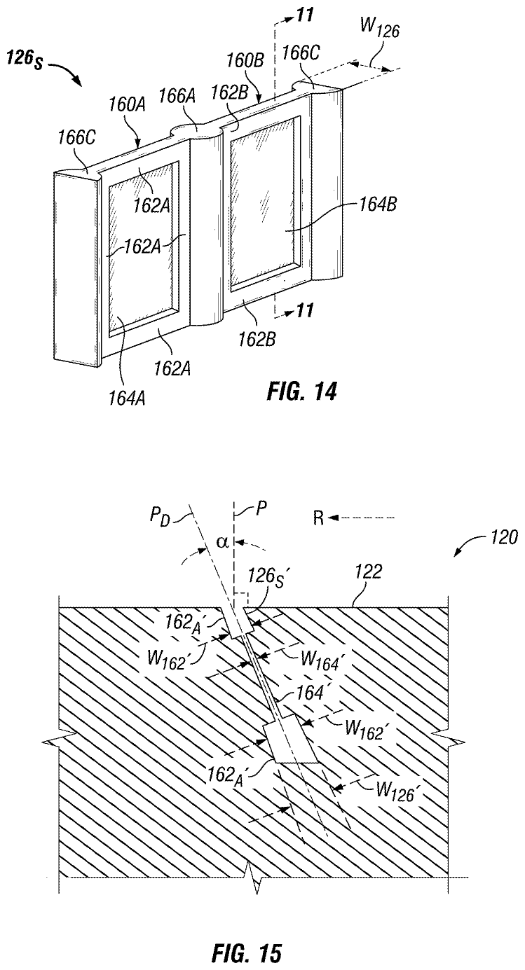

As stated previously, the adaptation of positively inclining a sipe and altering its thickness to increase with increasing depth may be applied to any other desired sipe. For example, these features may be applied to a windowpane sipe. With reference to FIGS. 13 and 14, conventional windowpane sipes are shown. In FIG. 13, a tire tread 120 is shown that includes a windowpane sipe 126s. The tire tread 120 includes a plurality of tread blocks 128 separated by longitudinal grooves 124 and lateral grooves 126g. The tire tread 120 extends in directions of the tread length L₁₂₀, tread width W₁₂₀, and tread thickness T₁₂₀. Sipe 126s has a variable width W₁₂₆ (a “thickness”) extending perpendicular to its height H₁₂₆ and length L₁₂₆. As best seen in FIG. 13, each sipe 126s is arranged between opposing faces 144, 146 of the tread extending within the tread thickness.

With continued reference to FIG. 13 as well as to FIG. 14, which represents the sipe formed in the tread of FIG. 13 (that is, the void forming the sipe within the tread). With specific regard to sipe 126s, the sipe is described as having a variable width W₁₂₆. The variableness in the width is at least provided by a first sipe portion 160A having a first thick portion 162A extending at least partially around a perimeter of a first thin portion 164A and a second sipe portion 160B having a second thick portion 162B extending at least partially around a perimeter of a second thin portion 164B, the first sipe portion spaced apart from the second sipe portion along the sipe length L₁₂₆. Of course, first thin portion 164A has a width W₁₆₄ that is less than a width W₁₆₂ of the first thick portion 162A, while second thin portion 164B has a width W₁₆₄ that is less than a width W₁₆₂ of the second thick portion 162B. It is apparent in FIG. 14 that first thick portion 162A completely surrounds first thin portion 164B along perimeter PE₁₂₆, while second thick portion 162B completely surrounds second thin portion 164B along perimeter PE₁₂₆. It is also noted that sipe 126s optionally includes a first upright void feature 166A arranged between and in fluid connection with each of the first and second sipe portions 160A, 160B. Sipe 126s also optionally includes a second upright void feature 166B arranged in fluid connection with the first sipe portion 160A, the first sipe portion 160A arranged between the first and second upright void features 166A, 166B, and a third upright void feature 166C arranged in fluid connection with the second sipe portion 160B, the second sipe portion 160B arranged between the first and third upright void features 166A, 166C.

In FIG. 15, the conventional windowpane sipe 126s of FIGS. 13 and 14 is shown positively inclined and having a width that increases with increasing depth. Specifically, adapted windowpane sipe 126s′ is shown to extend along path P_{D} having an average inclination angle α that is positive. As to the width W_{126′}, for each of the first thick portion 162A′ and the first thin portion 164A′, the respective widths W_{162′}, W_{164′} increase as the sipe 126s′ extends deeper into the tread thickness to provide the increasing width W_{126′}. Accordingly, any desired sipe may be adapted to being positively inclined and having a width that increases with increasing tread depth. The depthwise extension of the lateral windowpane sipe 126s′ can also be described as having a thin portion (that is, the portion associated with each thin portion 164A′, 164B′) and a wide portion (that is, the portion associated with each thick portion 162A′, 162B′ located at the depthwise terminal end of sipe 126′), the thin portion having a width that is less than a width of the wide portion.

To the extent used, the terms “comprising,” “including,” and “having,” or any variation thereof, as used in the claims and/or specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the embodiments. Ranges that are described as being “between a and b” are inclusive of the values for “a” and “b” unless otherwise specified.

While various improvements have been described herein with reference to particular embodiments thereof, it shall be understood that such description is by way of illustration only and should not be construed as limiting the scope of any claimed invention. Accordingly, the scope and content of any claimed invention is to be defined only by the terms of the following claims, in the present form or as amended during prosecution or pursued in any continuation application. Furthermore, it is understood that the features of any specific embodiment discussed herein may be combined with one or more features of any one or more embodiments otherwise discussed or contemplated herein unless otherwise stated.

1. A tire tread, comprising:
a length extending in a longitudinal direction, the longitudinal direction being a circumferential direction when the tread is arranged on a tire;
a width extending in a lateral direction, the lateral direction being perpendicular to the longitudinal direction;
a thickness extending in a depthwise direction from an outer, ground-engaging side of the tread, the depthwise direction being perpendicular to both the longitudinal direction and the widthwise direction of the tread;
a lateral sipe arranged within the tread, the sipe having a length extending primarily in the direction of the tread width and a width extending perpendicular to the lateral sipe length, the sipe having a depthwise extension extending into the tread thickness from a first terminal end to a second terminal end along a path by a height measured in the direction of the tread thickness, the first terminal end being arranged closest to the outer, ground-engaging side relative to the second terminal end, the path having an average inclination angle that is measured in the longitudinal direction of the tread relative to the depthwise direction, the average inclination angle being angled toward an intended forward rotating direction of the tread in the longitudinal direction,
where the sipe width is formed by a pair of opposing faces of the tread extending depthwise within the tread thickness, the sipe width being configured to, at an unworn stage, close along at least a portion of the sipe depth during operation of a loaded tire, and being configured to, at a worn stage, remain open during operation of the loaded tire, where in the worn stage, at least a portion of the tread thickness is 25% worn,
where the lateral sipe is characterized as having a width-to-height ratio associating the sipe width to the sipe height, the width-to-height ratio equaling 1:10 to 1:40.

2. The tire tread of claim 1, where the sipe width is constant.

3. The tire tread of claim 1, where the sipe width is variable and increases as the sipe extends from the first terminal end to the second terminal end of the sipe.

4. The tire tread of claim 3, where the sipe width increases linearly.

5. The tire tread of claim 3, where the sipe width increases non-linearly.

6. The tire tread of claim 1, where the sipe width increases at least partially in stepped increments.

7. The tire tread of claim 1, where the sipe width increases across the full length of the sipe.

8. The tire tread of claim 1, where the sipe extends into the tread from the outer, ground-engaging side of the tread, such that the first terminal end of the sipe is arranged along the outer, ground-engaging side.

9. The tire tread according to claim 1, where the length of the sipe extends along a linear path.

10. The tire tread according to claim 9, where the linear path extends in the lateral direction of the tread.

11. The tire tread according to claim 1, where the first terminal end has a width equal to 0 to 0.2 mm.

12. The tire tread according to claim 1, where the second terminal end has a width equal to or greater than 0.15 mm.

13. The tire tread according to claim 1, where the sipe width is equal to 0 to 0.2 mm at any location along the depthwise extension of the sipe.

14. The tire tread according to claim 1, where a submerged lateral groove extends from the second terminal end of the lateral sipe.

15. The tire tread according to claim 1, where the lateral sipe forms one of a plurality of lateral sipes arranged at different locations along the tread length and width.

16. The tire tread according to claim 1, where the tire tread forms a portion of a tire.

17. A method of forming a lateral sipe in a tire tread, the tire tread having a length extending in a longitudinal direction, the longitudinal direction being a circumferential direction when the tread is arranged on a tire, a width extending in a lateral direction, the lateral direction being perpendicular to the longitudinal direction, and a thickness extending in a depthwise direction from an outer, ground-engaging side of the tread, the depthwise direction being perpendicular to both the longitudinal direction and the widthwise direction of the tread, the method comprising:
determining for improved wear performance an optimum positive inclination angle for a lateral void that remains open during tire operation,
forming a lateral sipe within the tread thickness, the lateral sipe having a length extending primarily in the direction of the tread width and a width extending perpendicular to the lateral sipe length, the lateral sipe having a depthwise extension extending into the tread thickness from a first terminal end to a second terminal end along a path by a height measured in the direction of the tread thickness, the first terminal end being arranged closest to the outer, ground-engaging side relative to the second terminal end, the path having an average inclination angle that is greater than the optimum positive inclination angle, the average inclination angle being measured in the longitudinal direction of the tread relative to the depthwise direction, the average inclination angle being angled toward an intended forward rotating direction of the tread in the longitudinal direction, the lateral sipe characterized as having a width-to-height ratio associating the lateral sipe width to the sipe height, the width-to-height ratio equaling 1:10 to 1:40, where the lateral sipe has a width formed by a pair of opposing faces of the tread extending depthwise within the tread thickness, the sipe width being configured to, at an unworn stage, close along at least a portion of the sipe depth during operation of a loaded tire, and being configured to, at a worn stage, remain open during operation of the loaded tire, where in the worn stage, at least a portion of the tread thickness is 25% worn.
